(19) United States
(12) Patent Application Publication
(10) Pub. No.: US 2007/0289213 A1
(43) Pub. Date: Dec. 20, 2007

(54) Irrigation systems

(76) Inventors: Andrew Van Geest, Smithville (CA); Albert Henry Ludo Brouwer, Vineland (CA)

Correspondence Address: Ralph A. Dowell of DOWELL & DOWELL P.C., 2111 Eisenhower Ave, Suite 406, Alexandria, VA, 22314, US

(21) Appl. No.: 11/444,540

(22) Filed: Jun. 1, 2006

(51) Int. Cl. A01G 31/06

(52) U.S. Cl. 47/62 C

(57) ABSTRACT

A system of irrigating a plurality of plants may include: a floor having an upper surface generally declining from an upper area location to a lower area location; an water delivery system for delivering an amount of water to the floor proximate the upper area location; and a drainage system for draining an excess portion of the amount of water from the floor. The system is operable to deliver water proximate the upper area location such that said amount water will flow toward the lower area location over the floor whereby a first portion of the amount of water flowing toward the lower area location will irrigate the plants. The system is also operable to drain an excess portion of the amount of water from the floor.

### FIELD OF THE INVENTION

This invention relates to floor irrigation systems.

### BACKGROUND

It is well known to irrigate plants including trees, bushes, flowers, algae (hereinafter referred to as “Plants”) in large scale growing operations. For example, irrigation systems are employed in large fields, vineyards, orchards and the like to provide water, and other nutrients, to Plants. In this document, the term “water” is used to include water, water in combination with one or more nutrients, a nutrient solution, or other fluid which it is desired to provide to Plants.

For many years top irrigation of Plants was employed. However this general category of irrigation has significant drawbacks including being relatively high in labor intensity and inconsistent and unreliable amounts of irrigation of Plants.

More recently the concept of sub-irrigation has been employed where Plants are irrigated from a water source located at a lower level and where the water may be introduced at the lower part, including the roots, of the Plants.

Several distinct types of sub-irrigation systems are known including the watering matt, ebb and flow, trough benches and flood floors (e.g. concrete floors). Each type of sub-irrigation system has its own advantages and disadvantages.

Flood floors, including in particular concrete flood floors, have become popular in large scale growing operations, particularly where a single Plants is being produced. The flood floors are often found in greenhouse locations where a protective transparent (e.g. glass) cover is provided over the floor. In known flood floors, typically a reinforced concrete floor is provided. The floor may consist of one or more continuous slabs of concrete which are supported on the ground/terrain by a suitable substrate (such as sand/gravel). The floor may have certain area locations that are positioned lower than other area locations. Sometimes, the floor will be sloped from one location to another location.

However in the known types of flood floors, the water is both introduced and drained in the vicinity of the same lower location(s) on the floor. Water is introduced at one or more relatively low locations and gradually the water level rises to introduce water to the higher locations on the floor. Thus, as the term implies, the floor is flooded as the water level gradually rises to cover the floor. Generally, during the introduction of the water onto the floor, the water does not have a significant flowing movement on the floor.

Once the Plants have been exposed to water for a period of time, no more water is introduced and the water that remains on the floor is drained. The water will first recede from the higher locations and then from the lowest locations as the flooded floor is drained.

It will be appreciated that this type of flood floor system will result in uneven amounts of irrigation. The Plants that is located at the higher locations on the floor will be subjected to less irrigation than the Plants located in the lower locations on the floor. This is undesirable.

In known flood floor irrigation systems, at least some of the same piping system that is used to deliver the water to the floor is also used to drain the excess water that has not been absorbed by the plants or evaporated. The excess water may well carry organic material, which can promote the growth of pathogenic organisms. Additionally, the excess water itself may hold pathogenic organisms. Thus, the excess water may result in the common piping becoming infected with pathogenic organisms. The result can be, that when water is fed onto the floor, the pathogenic organisms can be spread to many of the plants growing on the floor.

Accordingly, an improved floor irrigation system is desirable.

### SUMMARY

In accordance with an aspect of the present invention there is provided a method of irrigating a plurality of Plants located on a floor, the floor generally sloping from an upper area location to a lower area location, the method comprising: delivering an amount of water proximate the upper area location of the floor; allowing the amount of water delivered at the upper area location to flow past the Plants to the lower area location over the floor whereby a first portion of the amount of water will irrigate the Plants; and draining an excess portion of the amount of water from the floor proximate the lower location.

In accordance with another aspect of the present invention there is provided a method of irrigating a plurality of Plants located on a floor, the method comprising: introducing an amount of water on the floor and causing the amount of water to flow past the Plants whereby a first portion of the amount of water will irrigate the Plants; and draining an excess portion of the amount of water from the floor.

In accordance with a further aspect of the present invention there is provided a system of irrigating a plurality of Plants comprising: a floor having an upper surface generally declining from an upper area location to a lower area location; an water delivery system for delivering an amount of water to the floor proximate the upper area location; and a drainage system for draining an excess portion of the amount of water from the floor, the system operable to deliver water proximate the upper area location such that the amount water will flow toward the lower area location over the floor whereby a first portion of the amount of water flowing toward the lower area location will irrigate the Plants, the system also being operable to drain an excess portion of the amount of water from the floor.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In figures which illustrate by way of example only, embodiments of this invention:

FIG. 1 is a top, perspective view of a floor irrigation system;

FIG. 1A is an enlarged view at 1A in FIG. 1;

FIG. 1B is an enlarged view at 1B in FIG. 1;

FIG. 2 is a top perspective view of the floor irrigation system of FIG. 1, with portions deleted so as to illustrate the piping system in more detail;

FIG. 3 is a top plan view of a part marked 3 in FIG. 1 of the floor irrigation system therein; and

FIGS. 4A-E are sectional views at section 4-4 in FIG. 1.

### DETAILED DESCRIPTION

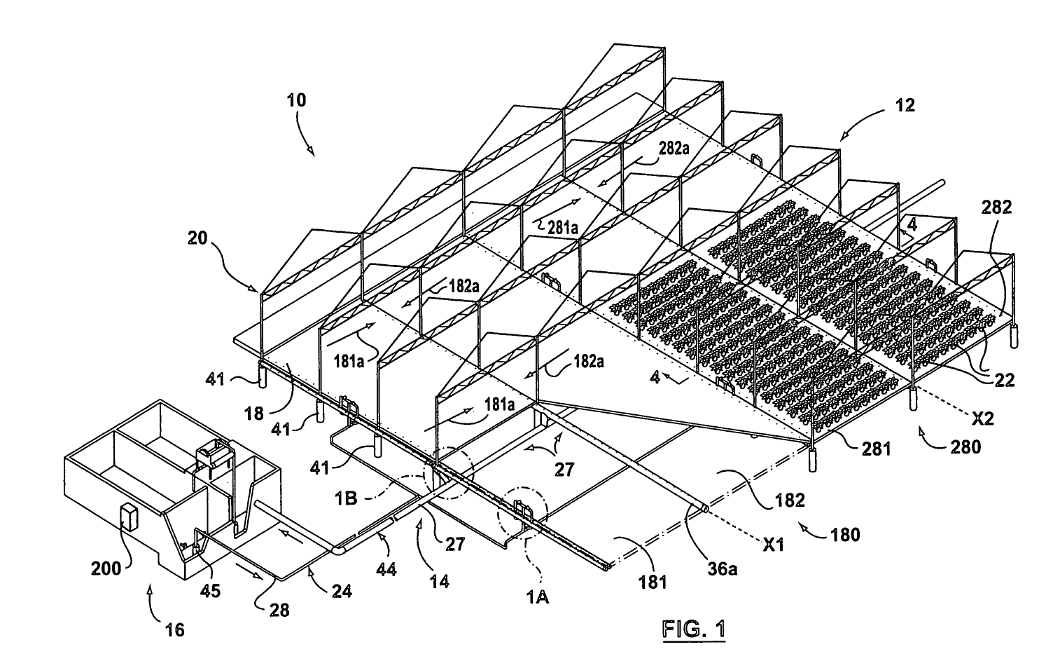

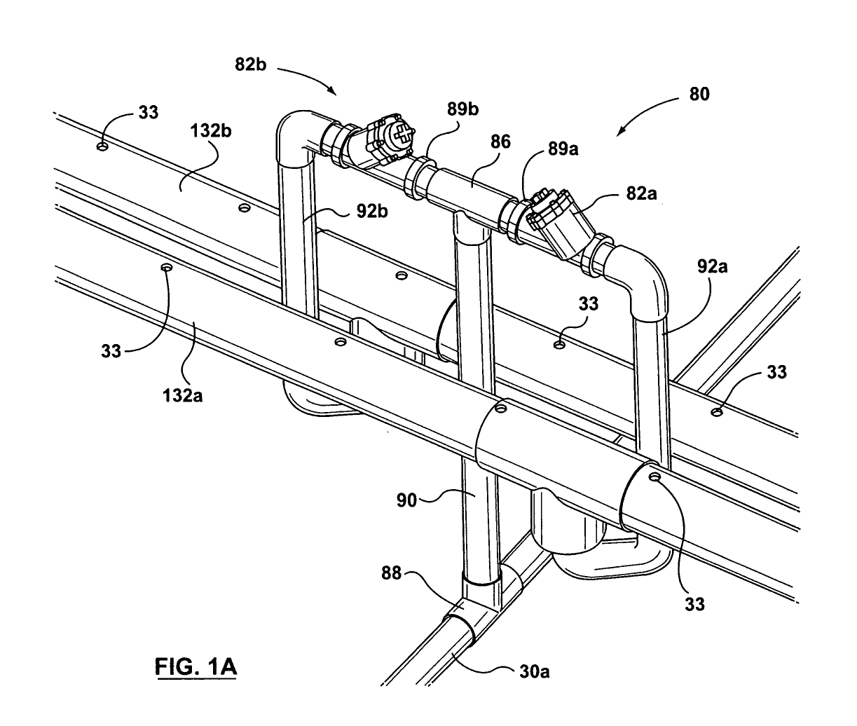

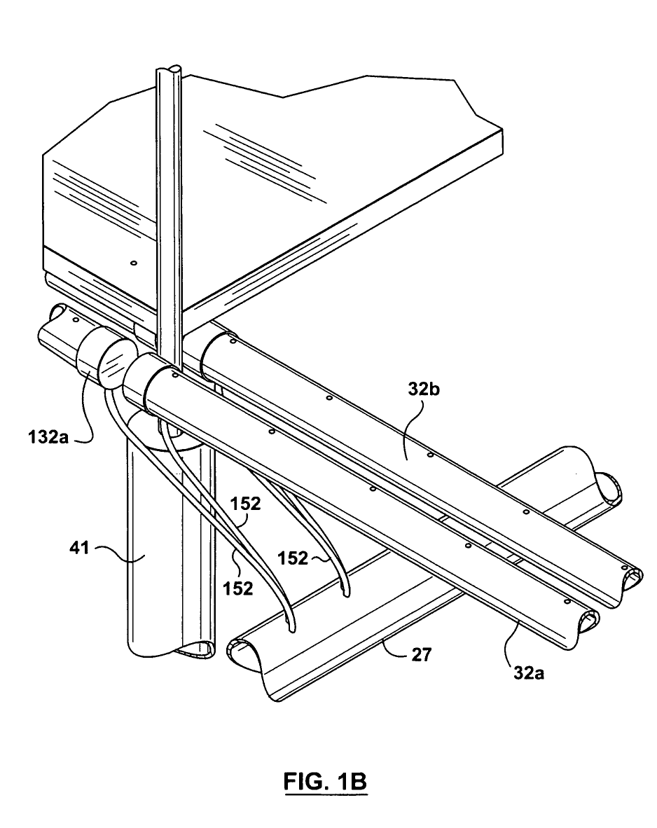

With reference to FIG. 1, one example embodiment of a Plants irrigation system 10 is illustrated. System 10 may have a greenhouse generally designated 12, a piping system generally designated 14 and a water pumping and treatment station 16.

Greenhouse 12 may have a floor 18 over which a superstructure 20 may be located. Floor 18 may be made from any suitable material including but not limited to concrete, which may be reinforced in known ways such as for example using steel bar reinforcement (commonly known as “rebar”). As will be further evident hereinafter, floor 18 may have one or more sections. Each section may have an upper surface which slopes from one or more generally higher locations to one or more generally lower locations.

As illustrated in FIG. 1, floor 18 can be divided into one or more floor sections such as sections 180 and 280. Floor section 180 may have two slabs 181 and 182 oriented in a generally V-shaped valley configuration about a common axis X1. Water on the upper surface of slabs 181, 182 may flow in the direction shown by arrows 181a, 182a toward the bottom of the valley proximate axis X1.

Likewise floor section 280 may have two slabs 281 and 282 oriented in a generally V-shaped valley configuration about common axis X2. Water on the upper surface of slabs 281, 282 may flow in the direction shown by arrows 281a, 282a toward the bottom of the valley proximate axis X2.

The slabs 181, 182 can be configured such that the upper surfaces are oriented generally horizontal in the longitudinal direction of axis X1. Likewise, slabs 281, 282 can be configured such that the upper surfaces are oriented generally horizontal in the longitudinal direction of axis X2. In other embodiments, the upper surfaces of the slabs may not be oriented horizontally in the longitudinal direction. For example, the axes X1 and X2 may be sloped in one direction or another or opposite directions.

In other embodiments, the upper surface of the floor 18 may be configured in other ways providing generally some kind of slope or decline from one or more generally higher locations to one or more generally lower locations.

Each floor section can be made of any suitable material that fulfills the design characteristics required of the system 10. The term floor as used herein is to be interpreted broadly and refers to any non-natural prepared surface supported proximate or on the underlying terrain and will include a material such as by way of example only a layer of concrete resting directly on the terrain.

Each floor slab section 181, 182, 281, 282 may be made from concrete using standard construction techniques and of any suitable depth. By way of example, each slab may be in the range of about 2 inches to about inches in depth, and may in some embodiments be chosen to be about 4 inches in depth. The concrete can be reinforced with steel reinforcement members, using processes and materials that are well known.

The floor slabs can be appropriately designed to withstand the necessary design loads including the loads that are associated with, for example, the Plants itself placed on the slabs, storage and person loads, vehicle loads, and other design loads.

Additionally, expansion joints can be provided within and between each slab section to allow for expansion and contraction of the slabs due to changes in temperature of the concrete slabs. The expansion joints may be configured so that they do not unduly interfere with the flow of the water over the upper surface of the floor slabs, as hereinafter described in more detail.

A sloped floor section can also be formed in known ways by, for example, preparing a sloped floor on grade, wherein a substrate supports the concrete slab. The sloped substrate may be formed in part from compacted foundation soil, gravel and/or sand. The uncured concrete may be poured onto the upper surface of the substrate and then finished in known ways to ensure an appropriate finish on the upper surface.

The finish of the upper surface of the concrete may be made sufficiently flat (i.e. so that the surface lies close to one or more planar surfaces). The surface may also be finished to be suitably smooth (i.e. low roughness) so that water moving over it may generally remain laminar with little turbulence. Deviations from a smooth surface of greater than about 1 mm to 4 mm may be avoided. This finish may be achieved with a smooth trowel finish.

In some example embodiments, average flow rates over the upper surface of the floor slabs may be in the range of about 0.5 to about 3.0 ft/sec. and may have an average depth in the range of about 0.1 inches to about 2.0 inches. The flow may be substantially laminar but may also some embodiments be turbulent.

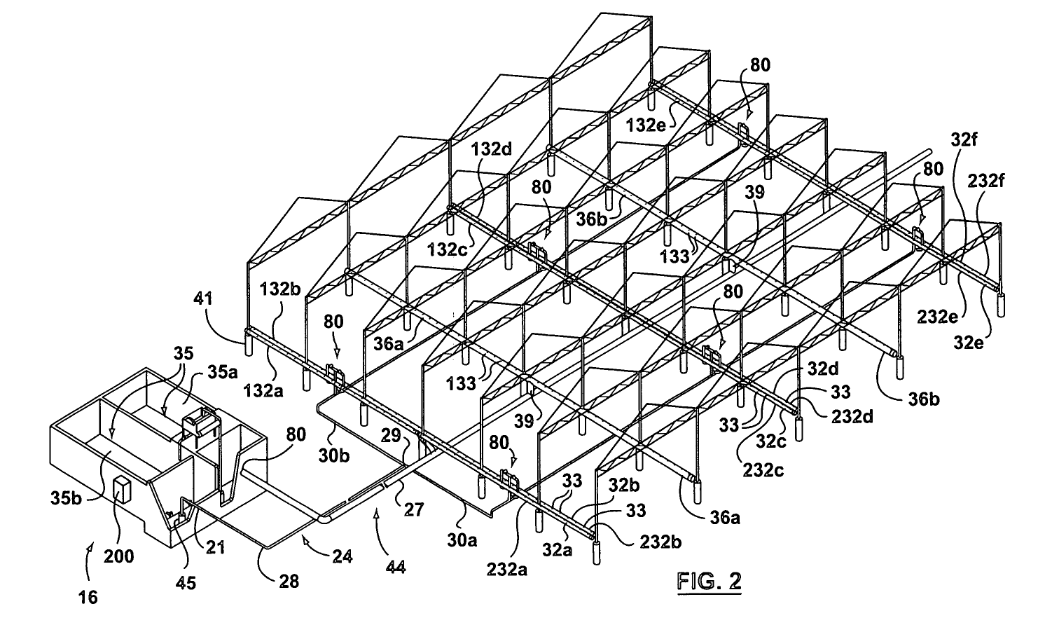

Returning to the example embodiment illustrated in FIGS. 1 and 2, the slope of the upper surfaces of slabs 181 and 182 towards the bottom of the V shaped valley and axis X1, may be in range of about 0.01 percent to about 2.0 percent, and may for example be about 1%. Likewise, the slope of the upper surfaces of slabs 281 and 282 toward the bottom of the v-shaped valley and axis X2, may also be in range of about 0.01 percent to about 2.0 percent, and may for example be about 1%. However, the slopes may in some embodiments possibly be less or more than this range, so long as the water will flow from one or more upper area locations to one or more lower area locations. For example slopes may be provided up to a 5% gradient. In some embodiments, these slopes may be provided in the longitudinal and/or lateral directions.

It is not necessary that the amount of the slopes of any of the slabs 181, 182, 281, 282 be the same or substantially the same. Also, the degree of slope may not be constant across the surface in either the transverse or longitudinal directions.

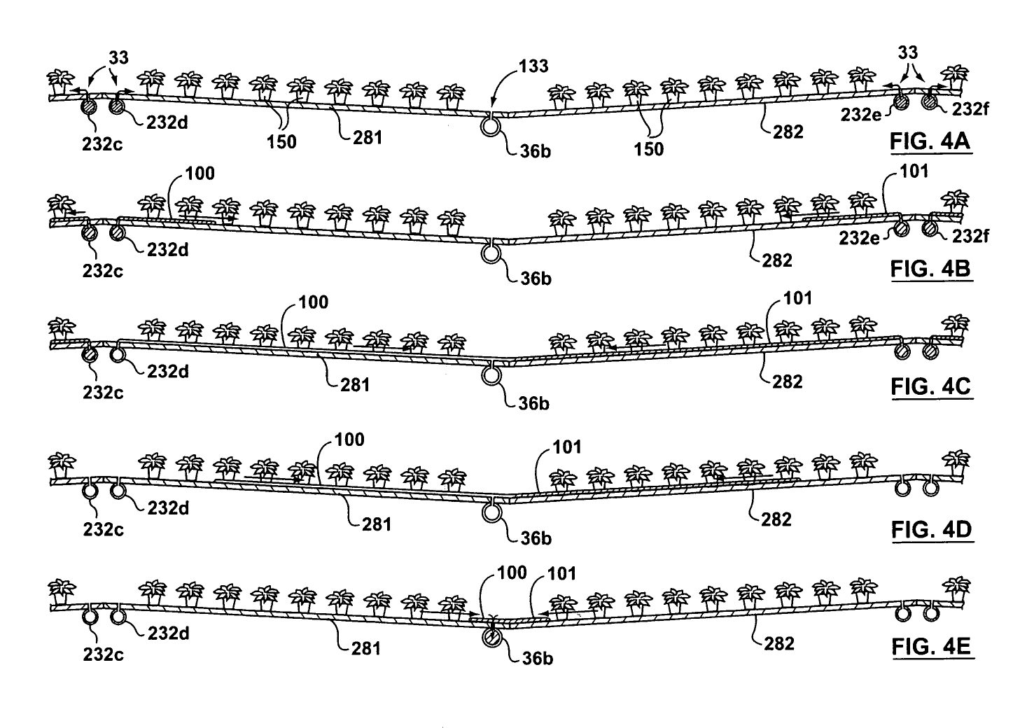

Positioned on floor sections 180 and 280 (only shown on part of section 280) are Plants 22, which may be any suitable crop or the like which it is desired to cultivate. The Plants may be held in pots or other containers 150 (see FIG. 4), with a growing medium, which may be soil or other known media, to hold the Plants therein and provide nutrients to the Plants. The containers 150 may be provided with openings suitable for allowing water that reaches the openings to penetrate inside the containers and be absorbed by the soil etc and thus provide a sustained source of water for the Plants.

In some embodiments, a container to hold the Plants may not be required and the Plants may be self-supporting and rest directly on the floor slab surface, or employ a self-supporting growing media, which rest on the floor and support the Plants.

Superstructure 20 may be provided for certain embodiments and may be any type of suitable kind, such as aluminum framing which is adapted to hold and support panels of transparent materials such as glass or some plastics. The framing of superstructure 20 can be supported on posts 41. Superstructure 20 can provide protection from the external environment, which is particularly important in certain climates.

Piping system 14 may include a water supply piping sub-system 24 and a water drainage sub-system 44.

With reference to both FIGS. 1 and 2, water supply piping sub-system 24 includes a main water supply pipe 28, which may be connected at an input end 21 to a water source which is provided at station 16. The water source communicates water under pressure to the main water supply pipe 28. Pipe 28 may be any suitable pipe such as 6-inch interior diameter pipe made from PVC or other suitable material.

Pipe 28 may communicate pressurized water to a T-junction 29, where water may then be communicated to one or more water supply sub-pipes or sub-lines such as sub-lines 30a and 30b, which may pass under the floor slabs of floor sections 180 and 280. Sub-lines 30a and 30b may be any suitable pipe or conduit such as 6 inch interior diameter pipe made from PVC or other suitable material.

Sub-lines 30a, 30b may run in generally spaced parallel relation to each other, generally transverse to the floor slabs of sections 180 and 280, and may be generally orthogonal to longitudinal axes X1 and X2. Sub-lines 30a, 30b supply pressurized water to a plurality of water distribution pipes 32a-32f each of which may run generally longitudinally. At least one water distribution pipe is in some way associated with each of the floor slabs of sections 180 and 280.

In the vicinity of, and beneath, the first peak of the V-shaped floor section 180, a water supply distribution pipe 32b may pass by and may cross (either under or over) sub-lines 30a and 30b. As illustrated, distribution pipe 32b may be divided into one or more separate sections such as section 132b and 232b. Distribution pipe 32b may lie within the substrate material and run in a generally longitudinal direction (generally parallel to axes X1) and generally orthogonal to sub-lines 30a and 30b. Thus, distribution pipe 32b may generally run in the vicinity of the first peak of the V-shaped valley of section 180.

In the vicinity of and beneath the opposite, second peak of the V-shaped floor section 180, a water supply distribution pipe 32c may also pass by and may cross over or under sub-lines 30a and 30b. Distribution pipe 32c may also lie in the substrate material and run in a generally longitudinal direction (generally parallel to axes X1) and generally orthogonal to sub-lines 30a and 30b. Thus distribution pipe 32c may generally run in the vicinity of the second peak of the v-shaped valley of section 180.

Distribution pipes 32b and 32c may be interconnected to sub-lines 30a and 30b through separate pipe and valve mechanisms, one of which is shown in more detail in FIG. 1A. Section 132b of pipe 32b and section 132c of pipe 32c, may be supplied with water from sub-line 30b. Likewise section 232b of pipe 32b and section 232c of pipe 32c may be supplied with water from sub-line 30a.

The water supply piping of section 280 may be substantially the same as section 180. In the vicinity of, and beneath the first peak of the V-shaped valley floor section 280, a water supply distribution pipe 32d may pass by and may cross (either under or over) sub-lines 30a and 30b. Distribution pipe 32d may run in a generally longitudinal direction (generally parallel to axis X2) and generally orthogonal to sub-lines 30a and 30b. Thus, distribution pipe 32d may generally run in the vicinity of the first peak of the v-shaped valley section 280 (which may also be in the vicinity of or correspond with the second peak of section 180).

In the vicinity of the opposite, second peak of the V-shaped valley floor section 280, a water supply distribution pipe 32e may also pass by and may cross over sub-lines 30a and 30b. Distribution pipe 32e may also run in a generally longitudinal direction (generally parallel to axes X2) and generally orthogonal to sub-lines 30a and 30b. Thus, distribution pipe 32e may generally run in the vicinity of the second peak of the v-shaped valley section 280.

Water distribution pipes 32d and 32e may also be interconnected to sub-lines 30a and 30b through separate pipe and valve mechanisms, an example of which is shown in more detail in FIG. 1A. Section 132d of pipe 32d and section 132e of pipe 32e, may be supplied with water from sub-line 30b. Likewise section 232d of pipe 32d and section 232e of pipe 32e may be supplied with water from sub-line 30a.

FIGS. 1 and 2 also show water distribution lines 32a and 32f. These additional water distribution lines could be employed in additional floor sections for system 10, which for simplicity are not shown.

Each of water distribution lines 32a-f has in their upper surfaces a plurality of openings 33, which are in communication with passageways that pass upwards through the slabs of the floor. The passageways may be configured not to unduly restrict the flow of water to the upper surface of the floor slabs. Thus, water emitted under pressure through the upper openings 33 in pipes 32a-f will pass through the slab and be communicated onto the upper surfaces of the floor slabs.

The size and spacing of the openings 33 and the passageways through the slab can be selected to achieve the desired amount and type of water flow at the upper surface of each slab. For example, approximately 1 inch diameter holes can be provided at approximately 24 inches center to center spacing to supply approximately 10 US gallons per minute through each hole. The result can be that the water can exit the passageways in the slabs at a flow rate that substantially maintains a flow of water that runs along the upper surface of the concrete and avoids a turbulent or even geyser-like flow at the upper surface.

The water delivered through openings 33 can be selected to provide a suitable flow of water on the upper surfaces of the slabs 181, 182, 281, 282. The water flowing out of the openings 33 can be configured in some embodiments so that water will substantially flow down the slope in a cascading sheet of water having an average depth in the range of about 0.25 to about 2.0 inches. In some embodiments the average depth of the water that flows on the upper surface may be about 0.375 inches.

By providing that each of supply distribution pipes 32a-f is divided into separate sections, such as for example 132a-f and 232a-f, it is possible to achieve a more even flow of water over the upper surface of the slabs. Each of water supply lines 30a, 30b may supply substantially the same amount of water and be introduced at a location that divides the pipe lengths 32a-f. Additionally each section may be divided into approximately equal longitudinal lengths and the lengths may be configured to be not so long that there is a significant pressure drop longitudinally in each pipe 30a-f.

Additionally, by dividing the water distribution system into separate sections, it is possible that only selected longitudinal sections of the floor might be irrigated during particular time periods (i.e. It is not necessary to have to provide water over the entire surface of the floor 18.

As shown in FIGS. 1 and 2, the distribution pipes 32a-f may be beneath the section floor slabs 181, 182 and 281, 282. The pipes 32a-f may have openings 33 in communication with passageways through the slab thickness, to provide water that emanates from beneath the upper surfaces of the slabs onto the upper surface. In other example embodiments, the distribution pipes may be situated with openings substantially at or a certain distance above the upper surface of the floor slabs 181, 182 and 281, 282. However, the design may be selected so that the water which reaches the upper surfaces of the slabs creates a generally laminar flow of water down the slope.

With reference now to FIG. 1A, an example of an inter-connection system generally designated 80 is shown which can interconnect a representative water supply sub-line 30a with each of water distribution pipe sections 132a and 132b. Interconnection system 80 may include a T-connector 88, which may connect a first end of a standpipe section 90 with sub-line 30a. The second, opposite end of standpipe section 90 may be interconnected to a second T-connector 86, which may have two outlets 89a, 89b. Outlet 89a may be connected to an inlet of a valve 82a. The outlet of the valve 82a may be connected to one end of a pipe section 92a, which at the opposite end may be connected to distribution section 132a. Outlet 89b may be connected to an inlet of a valve 82b. The outlet of the valve 82b may be connected to the end of a pipe section 92b, which at the opposite end may be connected to distribution section 132b.

Valves 82a, 82b may be any suitable valve devices, such as for example a direct lift valve or solenoid valve. An example of a suitable valve is a plunger valve made by Zwart Systems. The valves 82a 82b can be controlled electronically by a Programmable Logic Controller or suitable computer device 200 such at the environmental computers made by Priva Computers Inc. and Argus Control Systems Limited. Computer 200 can be employed to operate and control many or all aspects of the operation of system 10, including the temperature in the superstructure, and the irrigation of the Plants as described below in further detail.

All of the water supply sub-lines may be similarly interconnected with each of the water distribution pipe sections.

System 10 may also include a water drainage piping system 44 that includes a main drainage pipe 27. The main drainage pipe 27 may be connected at an outlet end 80 to a water storage and treatment system at the water pump and treatment station 16. Pipe 27 may be any suitable pipe such as 6 inch interior diameter pipe made from PVC or any other suitable material. Pipe 27 may receive excess or run-off water from longitudinally oriented drainage water receiving pipes 36a and 36b. Pipe 27 may be sloped for gravity feed of the water towards station 16. In some embodiments, drainage system 44 including main drain pipe 27, may be selected to accommodate about 90% of the amount of water supplied to floor 18 by the water supply piping system 24. Drainage system 44 can be as a whole adequately sized to ensure the continuous drainage of all excess water and thus avoid any “back-ups.”

The main drainage pipe 27 can be interconnected to each of pipes 36a, 36b at a medial location of the pipes through a T-junction connection 39. Each of receiving drainage pipes 36a and 36b may be located so as to pass under the upper surface of floor slabs of floor sections 180 and 181, and indeed may be under each of the entire slab of each section and run in the substrate. Receiving drainage pipes 36a and 30b may run in generally spaced parallel relation and generally parallel to their respective axis X1 and X2 and slope longitudinally from opposite ends towards medial locations at the T-junction connection 39. Accordingly, water in pipe 36a may generally run beneath and in the vicinity of the trough of the upper surface of v-shaped valley section 180. Likewise pipe 36b may run generally beneath and in the vicinity of the trough of the upper surface of v-shaped valley section 280. Also, water in pipes 36a and 36b may run into and be communicated into main drainage pipe 27.

Openings 133 may be provided at spaced intervals along the top of pipes 36a, 36b and may be in communication with openings or passageways thorough the floor slabs. Therefore, water that drains into the bottom of the V-shaped valley sections 180, 280 may pass through the upper surface of the floor slabs and pass into the pipes 36a, 36b. The size of the openings 133 and corresponding passageways through the slabs may be chosen to ensure appropriate draining of the excess water. The selection may be done to ensure that there is substantially little or no water build up in the bottom of the valley sections (i.e. substantially no flooding takes place). For example, openings 133 may be provided with accompanying passageways through the slabs that are 2 inches in diameter at 12-inch center to center spacing.

A barrier device (not shown) may be provided to run longitudinally at the bottom of the v-shaped valley of sections 180 and 181. The barrier device may pass over and link each of openings 133. The purpose of the barrier device is to inhibit water flowing down the slope of the section slabs on one side of the v-shaped valley section, running past the openings 133 and start to climb the opposite side slab. By providing the barrier, the plants near the vicinity of the bottom of the valley proximate the openings 133, will not be subjected to additional amounts of water due to a spillover effect. The barrier device can be any suitable device such as a flexible rubber dam device that is commercially available.

With reference now to FIG. 1B, additional drain tubes or pipes (which may be for example 16 mm tubes 152 made from any suitable material including polyethylene), may be provided. Tubes 152 provide fluid communication between pipe sections 32a, 132a, 32b and 132b (not shown) and drainage pipe 27. Drain tubes 152 assist in reducing the build up of any significant amounts of stagnant water in these pipe sections. Tubes 152 may be provided with separate valves (not shown) which can be closed during the irrigation of the Plants when water is fed to the water distribution pipes. Alternatively, since tubes may be narrow in internal diameter, the tube passageway may remain open during the irrigation cycle but little of the overall supply of water will pass through tubes 152.

Returning again to FIGS. 1 and 2, station 16 may provide for system 10 a water storage, treatment and pumping capability and complete the fluid flow circuit. Additionally water that is lost from the system either to evaporation or in the irrigation of the Plants, can be replaced from an external water source such as the main municipal water system.

Water tanks 35 may be used to hold the water that is used in the system and may comprise a tank 35a and tank 35b. Water held in tank 35a may be subjected to known types of water treatment processes which include for example filtration and Ultra violet treatment. The treated water is then passed to storage tank 35b where it is held. Water can be drawn from tank 35b on demand by a pump 45 and the passed under pressure to main supply line 28. Pump 45 may be any suitable pump which has the performance characteristics required for the system 10 and may for example be a model WS 5032 pump made by Gould.

Additionally, environmental computer 200 may be housed at station 16 and can be used to operate and control various aspects of the system 10 including the operation of the pump 45, the valves 82a, 82b and various aspects of the water treatment. Computer 200 can be interconnected with various types of sensors located in the vicinity of the Plants. These sensors can for example measure the ambient humidity and temperature. Additionally moisture level sensors might be provided to detect the moisture in, for example, the growing medium, or of the one or more Plants. Upon receipt of appropriate signals from sensors or otherwise the computer 200 can be programmed to provide for irrigation of the Plants in any particular section of the floor 18. Slab sections can be selectively irrigated at different times and/or different lengths of time, depending upon the desired irrigation. In this way, for example, different types of Plants may be irrigated on different sections of the floor 18, for different periods of time and at different times.

Of course, aspects of the system 10 may be controlled additionally or alternatively by manual intervention.

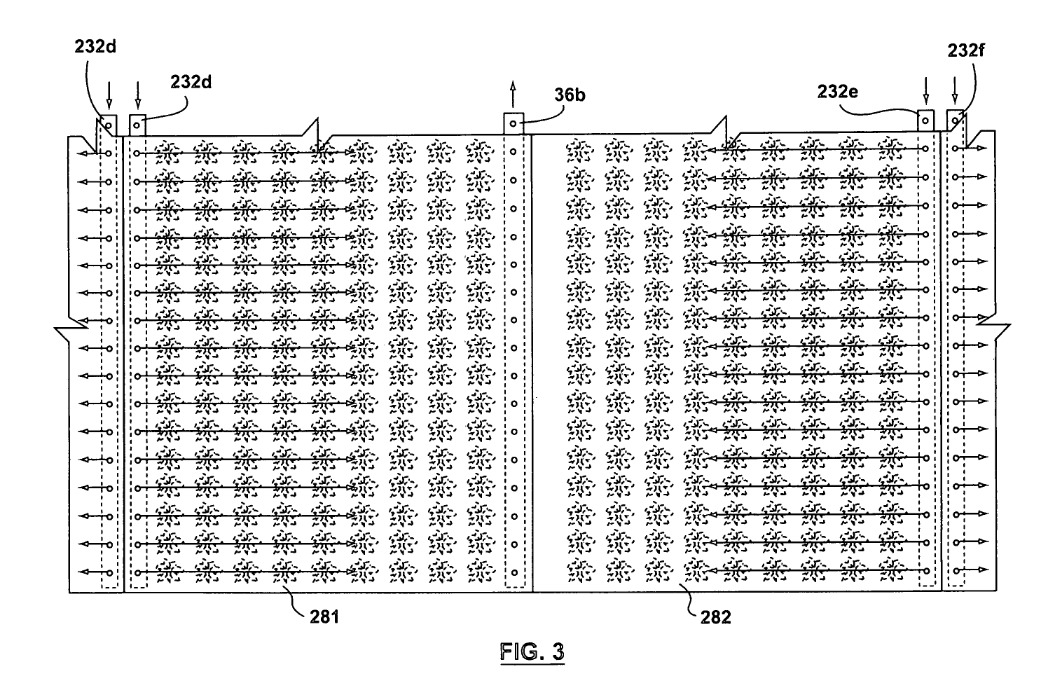

With reference now to FIGS. 3 and 4A-E, the operation of the system 10 in performing an irrigation cycle for floor sections 281, 282 is illustrated.

As shown progressively in FIGS. 4A-E, the water may be first supplied to the upper surfaces of floor slab sections 281, 282 through supply system 24 as described above, as shown in FIG. 4A. This may be effected by computer 200 turning on the pump 45 and opening the appropriate valves 82a, 82b. The result is that sheets of water 100, 101 may then start to flow from distribution pipe sections 232d, 232e down the upper surface of the slabs 281 and 282, respectively. The water may establish a fairly uniform and laminar flow as water starts to flow as shown in FIG. 4B. This process continues until an equilibrium flow regime as illustrated in FIG. 4C is established in which a continuous flow of water may be established between the distribution pipe sections 232d, 232e and the common drain pipe section 36a.

The flow regime established in FIG. 4C can be maintained for any period of time that it is desired to provide appropriate irrigation of the Plants. For example, this water flow may be maintained for a period of time in the range of about 30 seconds to about 20 minutes.

When water flows past the pots or other containers in which the Plants are held, a portion of that water will enter through openings in the pots and be absorbed therein.

After the Plants have been irrigated sufficiently, the water supply will be terminated and no additional water will emanate from the water distribution pipe sections 232d and 232e. Thus the terminal end of the sheets of water 100, 101 will gradually move down the slope as shown in FIGS. 4D and 4E.

The foregoing description of water flow across the floor surface can occur on any or all of the slab sections 181, 182 and 281, 282 (or parts thereof) to the extent to which water is supplied to and emanates from one or more of water distribution pipe sections 132b-e and 232b-e.

In other embodiments, the continuous sheet of water shown in FIG. 4C may never be established in an irrigation cycle. A sheet of water having a front end and a rear end may simply be generated which then passes down the slope.

The irrigation cycles can be varied and can be repeated as required in the particular application.

In this document the use of the term “including” means “including without limitation” and is not to be construed to limit any general statement which it follows to the specific or similar items or matters immediately following it.

The foregoing relates to only exemplary embodiments of the invention, it being understood that numerous other modifications, variants, embodiments and changes are possible within the scope and spirit of the invention.

1. A method of irrigating a plurality of Plants located on a floor, said floor generally sloping from an upper area location to a lower area location, said method comprising:
a. Delivering an amount of water proximate said upper area location of said floor;
b. Allowing the amount of water delivered at said upper area location to flow past said Plants to said lower area location over said floor whereby a first portion of said amount of water will irrigate said Plants;
c. Draining an excess portion of said amount of water from said floor proximate said lower location.

2. A method as claimed in claim 1 wherein said flow past said Plants is generally a laminar flow.

3. A method as claimed in claim 2 wherein said laminar flow as an average depth in the range of about 0.1 inches to about 2 inches.

4. A method of irrigating a plurality of Plants located on a floor, said method comprising:
a. Introducing an amount of water on said floor and causing said amount of water to flow past said Plants whereby a first portion of said amount of water will irrigate said Plants;
b. Draining an excess portion of said amount of water from said floor.

5. A method as claimed in claim 4 wherein said flow past said Plants is generally a laminar flow.

6. A method as claimed in claim 5 wherein said laminar flow as an average depth in the range of about 0.1 inches to about 2 inches.

7. A system of irrigating a plurality of Plants comprising:
a. a floor having an upper surface generally declining from an upper area location to a lower area location;
b. an water delivery system for delivering an amount of water to said floor proximate said upper area location;
c. a drainage system for draining an excess portion of said amount of water from said floor;
said system operable to deliver water proximate said upper area location such that said amount water will flow toward said lower area location over said floor whereby a first portion of said amount of water flowing toward said lower area location will irrigate said Plants, said system also being operable to drain an excess portion of said amount of water from said floor.

8. A system as claimed in claim 7 wherein said floor comprises at least a portion having a slope from said first upper area location to a said lower area location.

9. A system as claimed in claim 8 wherein said floor portion comprises a concrete floor slab.

10. A system as claimed in claim 8 wherein said floor comprises a first section having a first slope from a first upper area location to a first lower area location and a second section having a second slope from a second upper area location to a second lower area location.

11. A system as claimed in claim 10 wherein said first lower area location is proximate said second lower area location.

12. A system as claimed in claim 11 wherein said first area location is the same as said second lower area location.

13. A system as claimed in claim 7 further comprising a water storage and pumping station in communication with said fluid delivery system and said drainage system, wherein said water is pumped under pressure from said station through said fluid delivery system and a substantial amount of said excess portion of said water is returned by said drainage system to said storage and pumping station.

14. A system as claimed in claim 7 wherein said drainage system comprises at least one pipe in the vicinity of said lower area location such that said excess portion can be communicated into said at least one pipe.

15. A system as claimed in claim 14 wherein said irrigation delivery system comprises at least one water distribution pipe having an outlet for communicating said water to said upper surface of said floor.

16. A system as claimed in claim 15 further comprising a drainage tube for providing water communication between said at least one water distribution pipe and said drainage system, wherein said drainage tube is operable to pass said water in said at least one water distribution pipe to said water drainage system.

17. A system as claimed in claim 16 further comprising a station operable to pump water to said irrigation fluid delivery system.

18. A system as claimed in claim 17 wherein said station is in communication with and configured to store water provided to said station by said drainage system.

19. A system as claimed in claim 7 further comprising a station operable to pump water to said irrigation fluid delivery system.

20. A system as claimed in claim 19 wherein said station is in communication with and configured to store water provided to said station by said drainage system.

21. A system as claimed in claim 7 wherein said floor comprises a generally planar surface sloping from said upper area location to said lower area location.

22. A system as claimed in claim 7 wherein said floor comprises a first generally planar surface sloping from a first upper area location to a first lower area location and a second generally planar surface sloping from a second upper area location to a second lower area location.

23. A system as claimed in claim 22 wherein said first lower area location, is the same as said second lower area location.

24. A system as claimed in claim 23 wherein said first and second planar surfaces are generally configured in a generally v-shape.

25. A system as claimed in claim 7 further comprising a computer controller for controlling the delivery of water by said water delivery system.
